(19) United States
(12) Patent Application Publication
(10) Pub. No.: US 2016/0154099 A1
(43) Pub. Date: Jun. 2, 2016

(54) OBJECT DETECTION APPARATUS AND ROAD MIRROR

(71) Applicant: Panasonic Intellectual Property Management Co., Ltd., Osaka (JP)

(72) Inventors: YOSHIYUKI SAITO, Osaka (JP); MASAKATSU MAEDA, Osaka (JP)

(21) Appl. No.: 14/919,712

(22) Filed: Oct. 21, 2015

(30) Foreign Application Priority Data
Nov. 27, 2014 (JP) 2014-240316

(51) Int. Cl. G01S 13/04; G01S 13/93

(52) U.S. Cl. CPC G01S 13/04; G01S 13/931; G01S 2013/9332

(57) ABSTRACT

An object detection apparatus comprises: wireless-signal transmitting-receiving circuitry that transmits a wireless signal to a road mirror among one or more road mirrors provided at predetermined locations and receives a reflected-wave signal reflected by the road mirror, and control circuitry that detects the road mirror among the one or more road mirrors, and detects the presence of a moving object in accordance with (A) the transmitted wireless signal, and (B) the reflected-wave signal, which includes a signal received by the wireless-signal transmitting-receiving circuitry when at least part of the transmitted wireless signal is reflected by the road mirror and then reaches the moving object and is reflected by the moving object and then reaches the road mirror and reflected by the road mirror and then reaches the object detection apparatus.

### BACKGROUND

1. Technical Field

The present disclosure relates to an object detection apparatus that is mounted in a vehicle such as an automobile and that detects objects around the vehicle, and a road mirror that is recognized by the object detection apparatus.

2. Description of the Related Art

There is an object detection apparatus that detects objects around a vehicle using a radar or a camera mounted on the vehicle. With known object detection apparatuses, in the case where a building or a wall at a corner of an intersection causes a blind spot, a person or a vehicle traveling along an intersecting road may not be recognized.

Japanese Unexamined Patent Application Publication No. 2005-234999 has disclosed a technology in which images of the environment outside a vehicle are captured by a camera mounted on the vehicle, a road mirror is detected from the captured images, the movement of an object reflected in the road mirror is recognized by analyzing images of the detected road mirror.

Japanese Unexamined Patent Application Publication No. 2006-199055 has disclosed a technology in which a road mirror is recognized by combining images captured by a CCD camera and information supplied from a radar device, and it is estimated, in accordance with information on images reflected in the road mirror, whether or not there is any possibility that the vehicle will collide with an object present in the vehicle's blind spot.

### SUMMARY

In one general aspect, the techniques disclosed here feature an object detection apparatus according to an aspect of the present disclosure, the object detection apparatus including control circuitry and wireless-signal transmitting-receiving circuitry. The wireless-signal transmitting-receiving circuitry transmits a wireless signal to a road mirror among one or more road mirrors provided at predetermined locations and receives a reflected-wave signal that is a signal reflected by the road mirror. The control circuitry detects the road mirror among the one or more road mirrors, and detects the presence of a moving object in accordance with (A) the transmitted wireless signal, and (B) the reflected-wave signal, which is the signal received by the wireless-signal transmitting-receiving circuitry when the transmitted wireless signal is reflected by the road mirror and then reaches the moving object and is reflected by the moving object and then reaches the road mirror and reflected by the road mirror and then reaches the object detection apparatus.

According to the object detection apparatus according to the aspect of the present disclosure, the accuracy of detection of a moving object reflected in a road mirror may be improved.

It should be noted that general or specific embodiments of the present disclosure may be implemented as a road mirror, an apparatus, a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating the configuration of an object detection apparatus according to a first embodiment of the present disclosure;

FIG. 2 is a plan view illustrating the object detection apparatus of FIG. 1 and a road mirror;

FIG. 3 is a perspective view illustrating the road mirror of FIG. 2;

FIG. 4 is a perspective view illustrating a radar-wave reflector in the road mirror of FIG. 3;

FIG. 5 is a flowchart illustrating a moving-object detection process performed by the object detection apparatus of FIG. 1;

FIG. 6 is a perspective view illustrating a road mirror according to a modification of the first embodiment;

FIG. 7 is a perspective view illustrating a radar-wave reflector in the road mirror of FIG. 6;

FIG. 8 is a block diagram illustrating the configuration of an object detection apparatus and the configuration of a road mirror according to a second embodiment of the present disclosure;

FIG. 9 is a front view illustrating the road mirror of FIG. 8.

FIG. 10 is a flowchart illustrating a moving-object detection process performed by the object detection apparatus of FIG. 8;

FIG. 11 is a block diagram illustrating the configuration of an object detection apparatus according to a third embodiment of the present disclosure;

FIG. 12 is a perspective view illustrating the object detection apparatus of FIG. 11 and road mirrors;

FIG. 13 is a flowchart illustrating a moving-object detection process performed by the object detection apparatus of FIG. 11;

FIG. 14 is a block diagram illustrating the configuration of an object detection apparatus according to a fourth embodiment of the present disclosure; and

FIG. 15 is a flowchart illustrating a moving-object detection process performed by the object detection apparatus of FIG. 14.

### DETAILED DESCRIPTION

### Underlying Knowledge Forming Basis of the Present Disclosure

In Japanese Unexamined Patent Application Publication No. 2005-234999 and Japanese Unexamined Patent Application Publication No. 2006-199055, an object reflected in a road mirror is detected by performing image analysis on captured images of the road mirror. As a result, for example, the location and the speed of an object reflected in the road mirror may not be precisely detected. Thus, the inventors study diligently to provide an object detection apparatus that may detect, with high accuracy, a moving object reflected in a road mirror in comparison with the related art.

### First Embodiment

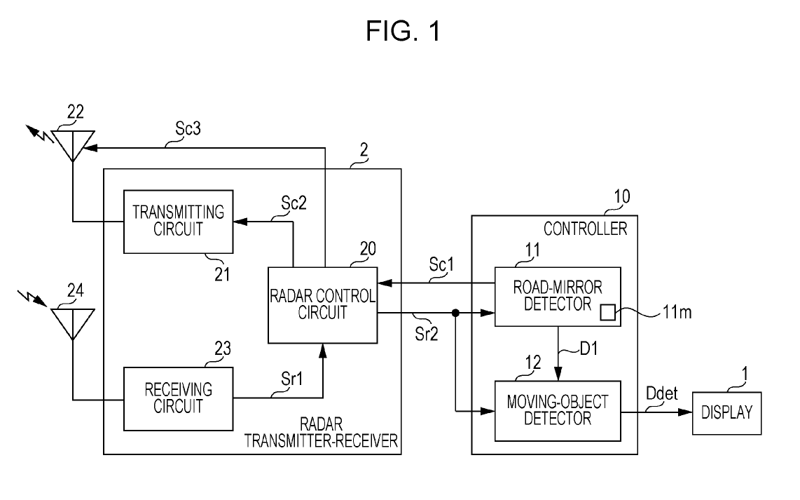

FIG. 1 is a block diagram illustrating the configuration of an object detection apparatus according to a first embodiment of the present disclosure. In FIG. 1, the object detection apparatus according to the present embodiment includes a radar transmitter-receiver 2, a controller 10, and a display 1. The radar transmitter-receiver 2 includes a millimeter-wave radar device, and includes a radar control circuit 20, a transmitting circuit 21, a transmitting antenna 22, a receiving circuit 23, and a receiving antenna 24. The controller 10 includes, for example, at least one selected from the group consisting of a central processing unit (CPU), a read-only memory (ROM), and a random-access memory (RAM), to implement a road-mirror detector 11 and a moving-object detector 12. The display 1 includes, for example, a liquid crystal display device.

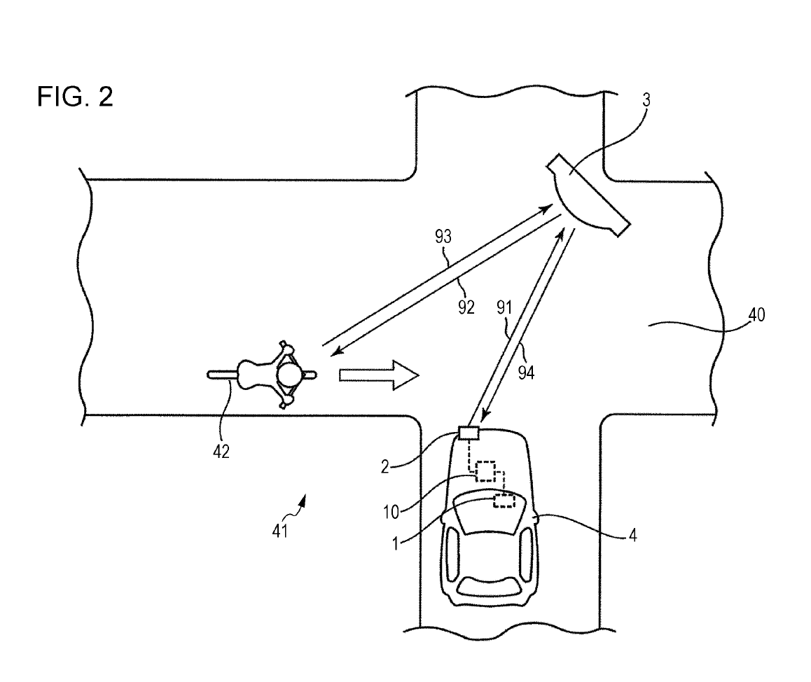

In FIG. 1, the road-mirror detector 11 of the controller 10 generates a radar control signal Sc1 used to detect a road mirror 3 to be described in detail later (see FIG. 2) and outputs the radar control signal Sc1 to the radar control circuit 20 of the radar transmitter-receiver 2. The radar control signal Sc1 is a control signal for controlling a radar-wave transmitting-receiving operation of the radar transmitter-receiver 2. Radar waves are electromagnetic waves having millimeter-wave-band frequencies of, for example, 76 to 81 GHz, and an example of a wireless signal to be scanned. The radar transmitter-receiver 2 is an example of a wireless-signal transmitter-receiver that emits radar waves by scanning a beam while transmitting a wireless signal, and that receives a reflected-wave signal of reflected waves of the radar waves.

The radar control circuit 20 generates a transmission control signal Sc2, which is used to control a wireless-signal transmitting operation, and outputs the transmission control signal Sc2 to the transmitting circuit 21 in accordance with the radar control signal Sc1, and in addition generates a transmitting-antenna control signal Sc3, which is used to scan and control the direction of a beam of the transmitting antenna 22, and outputs the transmitting-antenna control signal Sc3 to the transmitting antenna 22. The transmitting circuit 21 generates a wireless signal and outputs the wireless signal to the transmitting antenna 22 during a period corresponding to the transmission control signal Sc2 in accordance with the transmission control signal Sc2. The transmitting antenna 22 is, for example, a variable directional antenna including a phased array antenna, and scans the direction of a beam and emits radar waves in accordance with the transmitting-antenna control signal Sc3. Note that in the case where the transmitting antenna 22 includes a phased array antenna, the direction of a beam may be scanned by changing phases of wireless signals transmitted from a plurality of antenna elements included in the phased array antenna. Here, the transmitting-antenna control signal Sc3 may be a signal for setting a desired phase in a phase shifter that changes the phase of a wireless signal from each antenna element, and may also be included in the transmission control signal Sc2. In addition, in a mechanical beam scanning, the direction of a beam may also be scanned using the transmitting-antenna control signal Sc3.

The receiving antenna 24 includes an array antenna including a plurality of antennas arranged with a certain spacing therebetween, and the antennas receive reflected-wave signals of radar waves transmitted from the transmitting antenna 22. The receiving circuit 23 generates a received signal Sr1 in accordance with a plurality of reflected-wave signals received by the respective antennas of the receiving antenna 24, and outputs the received signal Sr1 to the radar control circuit 20. The radar control circuit 20 generates a radar signal Sr2 by performing certain signal processing on the received signal Sr1, and transmits the radar signal Sr2 to the road-mirror detector 11 and the moving-object detector 12 of the controller 10.

In the controller 10, the road-mirror detector 11 includes a memory 11m including, for example, a RAM. The memory 11m stores a road-mirror reflection pattern table including reflection patterns for scanned radar waves for a plurality of road mirrors 3 corresponding to a plurality of intersections. Reflection patterns are reflection intensity patterns of reflected waves that change along the time axis with respect to scanned radar waves, the reflected waves being waves reflected by specific objects. The road-mirror reflection pattern table is a data table including reflection patterns of road mirrors 3 with respect to the rotation angles of reflection surfaces of the road mirrors 3 obtained when, for example, the road mirrors 3 are provided such that the center of the reflection surface and installation axis of each of the road mirrors 3 are perpendicular to a road and the reflection surface is rotated on the installation axis. The road-mirror detector 11 extracts a reflection pattern of reflected-wave signals received in accordance with the radar signal Sr2. The road-mirror detector 11 detects, in accordance with the road-mirror reflection pattern table, the presence of the road mirror 3 by comparing an extracted reflection pattern with each reflection pattern included in the road-mirror reflection pattern table.

The road-mirror detector 11 calculates, for example, a correlation matrix and/or an evaluation function representing phase differences of a plurality of reflected-wave signals received by a plurality of antennas of the receiving antenna 24, in accordance with the radar signal Sr2 (see, for example, Japanese Unexamined Patent Application Publication No. 2014-163753). As a result, the road-mirror detector 11 estimates the direction from which reflected waves reflected by the road mirror 3 have come. The road-mirror detector 11 detects the location and the angle of the road mirror 3 with respect to the object detection apparatus in accordance with the detected reflection pattern and the estimated direction from which the reflected waves have come, generates road-mirror detection data D1 indicating the location and the angle of the road mirror 3, and outputs the road-mirror detection data D1 to the moving-object detector 12.

The moving-object detector 12 detects the presence of a moving object that has reflected radar waves via the road mirror 3 and the moving state of the moving object, which will be described in detail later, in accordance with the radar signal Sr2 and the road-mirror detection data D1. The moving state includes, for example, at least one selected from the group consisting of a direction of travel, a location, and a speed. The moving-object detector 12 generates moving-object detection data Ddet indicating the detected moving object and a detection result of its moving state, and outputs the moving-object detection data Ddet to the display 1. The display 1 displays information indicating the detected moving object and the detection result of the moving state of the detected moving object in accordance with the moving-object detection data Ddet supplied from the controller 10.

FIG. 2 is a plan view illustrating the object detection apparatus of FIG. 1 and the road mirror 3. In FIG. 2, the object detection apparatus according to the present embodiment is mounted in an automobile 4. The radar transmitter-receiver 2 is attached toward the front of the automobile 4. The controller 10 is installed inside the automobile 4. The display 1 is attached inside the automobile 4 on a driver's seat side. In addition, the road mirror 3 according to the present embodiment is installed at an intersection 40.

In FIG. 2, the automobile 4, in which the object detection apparatus according to the present embodiment is mounted, is about to enter the intersection 40 where the road mirror 3 is installed. At the intersection 40, a wall 41 on the left of the automobile 4 in the direction in which the automobile 4 is traveling causes a blind spot of the automobile 4. The road mirror 3 is installed at a certain location and a certain angle at the intersection 40 so as to reflect an area of such a blind spot of the automobile 4. A bicycle 42 is traveling at a location that is a blind spot of the automobile 4 at the intersection 40. The bicycle 42 traveling in the blind spot is not directly seen from the driver's seat of the automobile 4. In addition, even when the bicycle 42 is reflected in the road mirror 3, the bicycle 42 may not be easily seen from the automobile 4.

Here, as illustrated in FIG. 2, when a wireless signal is transmitted by the radar transmitter-receiver 2 to the road mirror 3, the transmitted wireless signal reaches the road mirror 3 through a route 91. After being reflected by the road mirror 3, the transmitted wireless signal reaches the bicycle 42 through a route 92 and is reflected by the bicycle 42. Furthermore, the reflected-wave signal that is a signal reflected by the bicycle 42 reaches the road mirror 3 through a route 93 and is reflected by the road mirror 3. Thereafter, the reflected-wave signal reaches the object detection apparatus through a route 94 and is received by the radar transmitter-receiver 2. In the present embodiment, the presence of the road mirror 3 is detected by analyzing a reflection pattern of the reflected waves received from the radar transmitter-receiver 2, and in addition moving objects such as the bicycle 42 reflected in the road mirror 3 are detected in accordance with the wireless signal and the reflected-wave signal that have traveled through the routes 91 to 94, the wireless signal being transmitted to the road mirror 3.

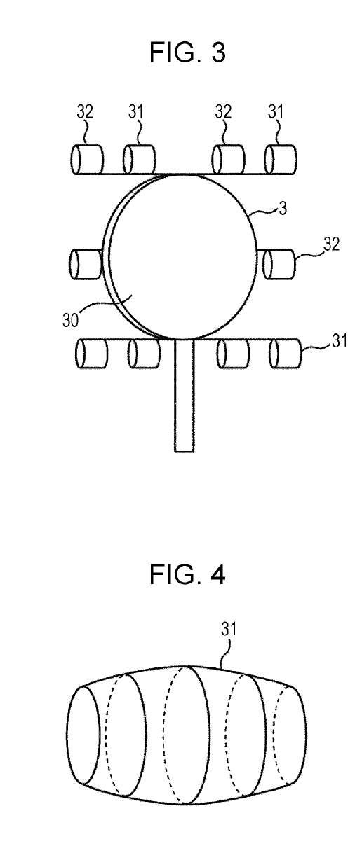

FIG. 3 is a perspective view illustrating the road mirror 3 of FIG. 2. FIG. 4 is a perspective view illustrating a radar-wave reflector 31 in the road mirror 3 of FIG. 3. In FIG. 3, the road mirror 3 includes a mirror 30 and a plurality of radar-wave reflectors 31 and 32. The reflecting surface of the mirror 30 reflects visible light and radar waves emitted from the radar transmitter-receiver 2. The plurality of radar-wave reflectors 31 and 32 are arranged around the mirror 30 in the road mirror 3. As illustrated in FIG. 4, the radar-wave reflector 31 has a substantially cylindrical shape, and the radar-wave reflector 31 is formed such that the diameter of a circular cross section of the radar-wave reflector 31 is larger in its central portion than in its end portions in the longitudinal direction of the radar-wave reflector 31. Each radar-wave reflector 32 has the same shape as the radar-wave reflector 31.

The radar-wave reflectors 31 and 32 are brought into alignment in terms of orientation and arranged such that the radar waves from the automobile 4 traveling along a road where the road mirror 3 is installed are reflected toward the automobile 4. In addition, the radar-wave reflectors 31 and 32 are alternately arranged around the mirror 30. Each radar-wave reflector 31 is composed of materials such as metal. In contrast, each radar-wave reflector 32 is composed of materials such as resin. Thus, the reflection intensity of the reflected waves from the radar-wave reflector 31 is higher than the reflection intensity of the reflected waves from the radar-wave reflector 32. The road mirror 3 according to the present embodiment generates a reflection pattern of reflected waves in which high reflection-intensity reflected waves and low reflection-intensity reflected waves are alternately arranged so as to surround the mirror 30, by receiving radar waves that are emitted as necessary.

With the object detection apparatus and the road mirror 3 configured as described above, a moving object is detected as in the following in the present embodiment.

First, an operation for detecting the moving state of an object that has reflected radar waves will be described, the operation being performed by the controller 10 of the object detection apparatus. The controller 10 extracts, in accordance with the radar signal Sr2 from the radar control circuit 20, a delay At and a reflection intensity Pw of a received reflected wave with respect to an emitted radar wave. Note that the radar control circuit 20 controls a transmitting operation for a radar wave using the transmission control signal Sc2, and generates the radar signal Sr2 including information on the emitted radar wave and the received reflected wave. In addition, the controller 10 detects a reflection angle θr of the received reflected wave by estimating the direction from which the received reflected wave has come. The controller 10 detects, in accordance with the radar signal Sr2, whether or not there is an object that has reflected the radar wave by determining whether or not the reflection intensity Pw of the received reflected wave exceeds a certain threshold. In the moving state of the detected object, the relative distance L with respect to the object detection apparatus is expressed in the following expression using the delay Δt of the reflected wave and the speed of light C.

L=C×Δt/2 (1)

The controller 10 calculates the relative distance L using Expression 1, and detects the relative location of the object with respect to the object detection apparatus in accordance with the calculated relative distance L and the reflection angle θr. In addition, in the moving state of the object, the relative speed V with respect to the object detection apparatus corresponds to the Doppler frequency fd, which is the difference in frequency between the radar wave and the reflected wave, on the basis of the Doppler effect. The relative speed V is expressed in the following expression using a frequency fo of the radar wave, the Doppler frequency fd, and the speed of light C.

V=C×fd/(2fo) (2)

The controller 10 detects the frequency fo of the emitted radar wave and the frequency fo+fd of the reflected wave by performing a fast Fourier transform (FFT) in accordance with the radar signal Sr2 supplied from the radar control circuit 20, and calculates the Doppler frequency fd. The controller 10 detects the relative speed V in accordance with the calculated Doppler frequency fd and the frequency fo of the radar wave using Expression 2. As described above, the controller 10 detects the moving state of the object in accordance with the radar signal Sr2.

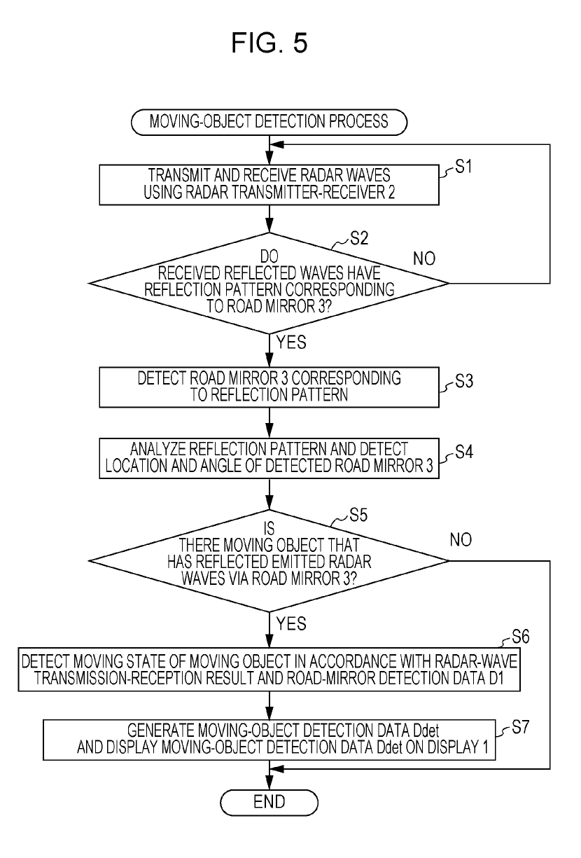

FIG. 5 is a flowchart illustrating a moving-object detection process performed by the object detection apparatus of FIG. 1. The moving-object detection process in FIG. 5 is performed by the controller 10 of the object detection apparatus. First, the controller 10 transmits and receives radar waves using the radar transmitter-receiver 2 by generating the radar control signal Sc1 and outputting the radar control signal Sc1 to the radar control circuit 20 (step S1). Radar waves are emitted from the transmitting antenna 22 of the radar transmitter-receiver 2 in accordance with the radar control signal Sc1 so as to scan a certain angle of area. The reflected waves of the emitted radar waves are received via the receiving antenna 24, and the radar signal Sr2 indicating a transmission-reception result is output to the controller 10.

Next, the controller 10 determines, in accordance with the radar signal Sr2 from the radar control circuit 20, whether or not the reflected waves received in step S1 have a reflection pattern of the road mirror 3 (step S2). The controller 10 reads out the road-mirror reflection pattern table, and performs the determination process of step S2 by comparing the read-out road-mirror reflection pattern table with the reflection pattern of the received reflected waves. In the case where it is determined that the received reflected waves do not have a reflection pattern of the road mirror 3 (NO in step S2), the controller 10 performs processing in step S1 again.

In contrast, in the case where it is determined that the reflected waves received in step S1 have a reflection pattern of the road mirror 3 (YES in step S2), the controller 10 detects the road mirror 3 corresponding to the reflection pattern for which the determination has been performed (step S3). Next, the controller 10 detects the location and the angle of the road mirror 3 detected in step S3 in accordance with the reflection pattern of the reflected waves received in step S1, and generates the road-mirror detection data D1 (step S4). The angle of the road mirror 3 is, for example, the angle of the direction normal to (the center point of) the reflecting surface of the road mirror 3 with respect to the direction in which the automobile 4 is traveling (see FIG. 2). The controller 10 realizes the function of the road-mirror detector 11 by performing processing described above.

Next, the controller 10 determines, in accordance with the radar signal Sr2, whether or not there is a moving object that has reflected, via the road mirror 3, the radar waves emitted from the radar transmitter-receiver 2 (step S5). The radar signal Sr2 is the transmission-reception result of step S1. In step S5, the controller 10 determines whether or not there is a moving object by determining whether or not the reflected waves received from the road mirror 3 include a reflected wave having the Doppler frequency higher than a certain value. In the case where it is determined that there is no moving object (NO in step S5), the controller 10 ends the present process.

In contrast, in the case where it is determined that there is a moving object (YES in step S5), the controller 10 detects the moving state of the moving object in accordance with the radar signal Sr2 and the road-mirror detection data D1 generated in step S4 (step S6). In the moving-state detection process in step S6, the controller 10 calculates the location of the moving object with respect to the road mirror 3 in accordance with the location and the angle of the road mirror 3 and the delay At and the reflection angle θr of the reflected wave with respect to the radar wave. In addition, the controller 10 detects the relative distance L and the relative speed V of the moving object using Expression 1 and Expression 2 in accordance with the reflected wave of the radar wave emitted to the road mirror 3, the reflected wave being received via the road mirror 3 from the moving object. Information of the reflected wave is included in the radar signal Sr2.

Here, the relative distance L is the length of a route from the object detection apparatus to the moving object via the road mirror 3, and is not the distance from the moving object to the object detection apparatus as the crow flies. Thus, the controller 10 detects the location of the moving object in accordance with the calculated location of the moving object with respect to the road mirror 3 and the detected relative distance L. In addition, the controller 10 detects the direction of travel of the moving object in accordance with the calculated location of the moving object with respect to the road mirror 3 and the detected relative speed V. The controller 10 realizes the function of the moving-object detector 12 by performing processing described above.

Next, the controller 10 generates the moving-object detection data Ddet indicating the detection result of step S6, outputs the moving-object detection data Ddet to the display 1, and ends the present process (step S7). The display 1 displays information indicating the moving state of the detected moving object in accordance with the moving-object detection data Ddet. The above-described moving-object detection process is repeatedly performed, for example, at intervals of 0.1 seconds.

The object detection apparatus configured as described above includes the road-mirror detector 11, the radar transmitter-receiver 2, and the moving-object detector 12. The road-mirror detector 11 detects the road mirror 3 which is a road mirror among a plurality of road mirrors provided at certain respective locations. The radar transmitter-receiver 2 transmits a wireless signal to the road mirror and receives a reflected-wave signal reflected by the road mirror. The moving-object detector 12 detects the presence of a moving object in accordance with (A) the transmitted wireless signal and (B) the reflected-wave signal, which includes a signal received by the radar transmitter-receiver 2 when at least part of the transmitted wireless signal is reflected by the road mirror and then reaches the moving object and is reflected by the moving object and then reaches the road mirror and reflected by the road mirror and then reaches the object detection apparatus.

As a result, compared with the related art, a moving object reflected in the road mirror may be detected with high accuracy.

In addition, the road mirror 3 configured as described above is a road mirror detected by the object detection apparatus, and includes the radar-wave reflectors 31 and 32, which reflect a wireless signal supplied from the radar transmitter-receiver 2 so as to form a certain reflection pattern.

As a result, the object detection apparatus may detect the presence of the road mirror 3 with high accuracy in accordance with the reflection pattern of the reflected-wave signal received by the radar transmitter-receiver 2.

### Modification of First Embodiment

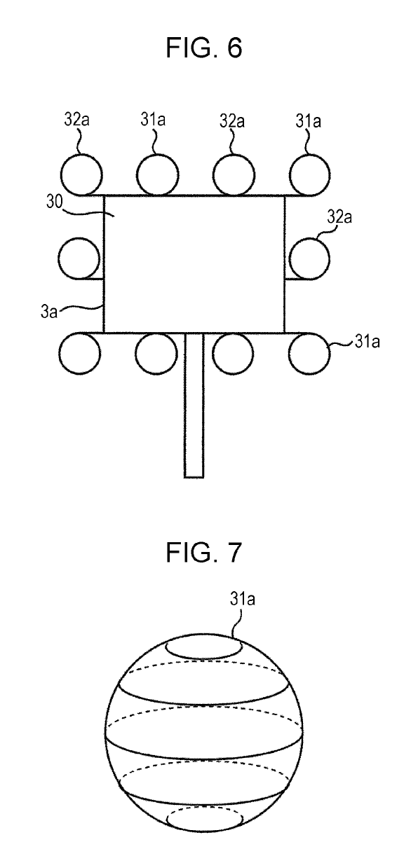

FIG. 6 is a perspective view illustrating a road mirror 3a according to a modification of the first embodiment. FIG. 7 is a perspective view illustrating a radar-wave reflector 31a in the road mirror 3a of FIG. 6. The radar-wave reflectors 31 and 32 of the road mirror 3 according to the first embodiment have a substantially cylindrical shape; however, the shapes of the radar-wave reflectors 31 and 32 are not limited to this shape and may also be, for example, a triangular prism shape or a sphere shape.

The road mirror 3a according to the modification of the first embodiment includes radar-wave reflectors 31a and 32a having a sphere shape as illustrated in FIG. 7. Since the radar-wave reflectors 31a and 32a have a sphere shape, the radar-wave reflectors 31a and 32a may reflect radar waves emitted from various directions opposite to the directions from which the radar waves have been emitted. In addition, the road-mirror detector 11 of the object detection apparatus according to the present embodiment stores a road-mirror reflection pattern table including reflection pattern tables of a plurality of types of road mirrors such as the road mirror 3 of FIG. 3 and the road mirror 3a of FIG. 6. Thus, the road-mirror detector 11 may detect various types of road mirrors such as the road mirrors 3 and 3a individually.

The reflection pattern is a pattern indicating an intensity distribution of reflected waves that change along the time axis in the object detection apparatus according to the first embodiment; however, the reflection pattern is not limited to this pattern and may also be, for example, a pattern indicating an intensity distribution of reflected waves that change along the spatial axis. For example, the road-mirror detector 11 estimates the directions from which the reflected waves of the plurality of radar-wave reflectors 31 and 32 have come in accordance with reflected-wave signals supplied from a plurality of respective antennas of the receiving antenna 24. Thereby, the road-mirror detector 11 extracts a reflection intensity pattern of the reflected waves in an angular distribution. Here, the road-mirror detector 11 may detect the location and the angle of the road mirror 3 by analyzing the size and the shape of the reflection pattern of the reflected waves.

In the road mirror 3 according to the first embodiment, the reflection pattern is generated in which high reflection intensity and low reflection intensity are alternately arranged, by arranging the radar-wave reflectors 31 and 32 made of different materials. However, other radar-wave reflectors may be used. For example, a plurality of radar-wave reflectors 31 having high reflection intensity such as metal may be arranged so as to surround the periphery of the mirror 30. Here, a frame-shaped reflection pattern having high reflection intensity is generated, and the road-mirror detector 11 analyzes such a frame-shaped reflection pattern.

### Second Embodiment

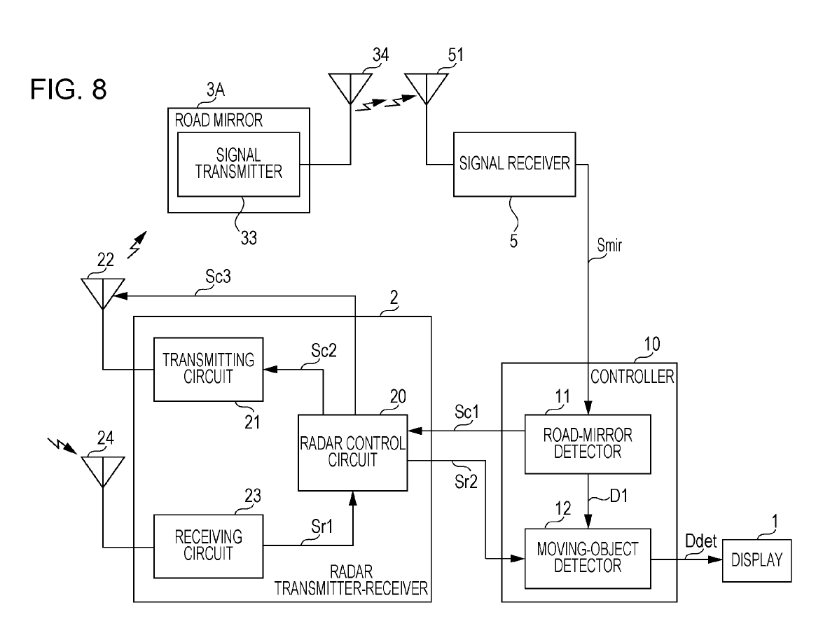

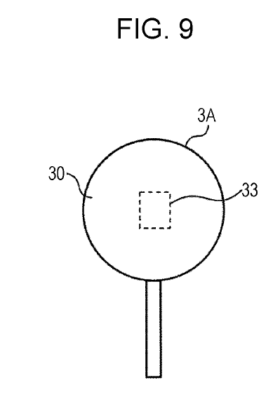

FIG. 8 is a block diagram illustrating the configuration of an object detection apparatus and the configuration of a road mirror 3A according to a second embodiment of the present disclosure. FIG. 9 is a front view illustrating the road mirror 3A of FIG. 8. In the first embodiment, the road mirrors 3 corresponding to certain reflection patterns are detected in accordance with the reflection patterns of the reflected waves received by the radar transmitter-receiver 2. In the second embodiment, certain wireless signals are transmitted from the road mirrors 3A, and the road mirrors 3A that have transmitted the wireless signals are detected by the object detection apparatus.

Compared with the object detection apparatus according to the first embodiment, the object detection apparatus according to the second embodiment further includes a signal receiver 5. Compared with the road mirror 3 according to the first embodiment, the road mirror 3A according to the second embodiment includes a signal transmitter 33 instead of the radar-wave reflectors 31 and 32. The other portions of the object detection apparatus according to the second embodiment are the same as those of the object detection apparatus according to the first embodiment. The differences will be described in the following.

In FIG. 8, the signal transmitter 33 of the road mirror 3A includes a transmitter that transmits a wireless signal of, for example, a frequency band of 400 MHz using specified low-power radio, and includes a transmitting antenna 34. The signal transmitter 33 is embedded inside the road mirror 3A as illustrated in FIG. 9. The signal transmitter 33 transmits, from the transmitting antenna 34, a road-mirror signal Smir including information indicating the location where the road mirror 3A is installed and the angle of the road mirror 3A. The angle of the road mirror 3A in the information included in the road-mirror signal Smir is, for example, the angle of the direction normal to (the center point of) the reflecting surface of the road mirror 3A with respect to a reference location such as the center of the intersection where the road mirror 3A is installed.

The signal receiver 5 includes a receiving antenna 51 in the object detection apparatus. The signal receiver 5 receives the road-mirror signal Smir transmitted from the signal transmitter 33 via the receiving antenna 51, and outputs the received road-mirror signal Smir to the controller 10. In the controller 10, the road-mirror detector 11 detects the location and the angle of the road mirror 3A in accordance with the road-mirror signal Smir supplied from the signal receiver 5. The road-mirror detector 11 generates the radar control signal Sc1, and outputs the radar control signal Sc1 to the radar control circuit 20 such that a beam is directed toward the location of the detected road mirror 3A and radar waves are emitted.

With the object detection apparatus and the road mirror 3A configured as described above, the object detection apparatus detects a moving object via the road mirror 3A as in the following in the present embodiment.

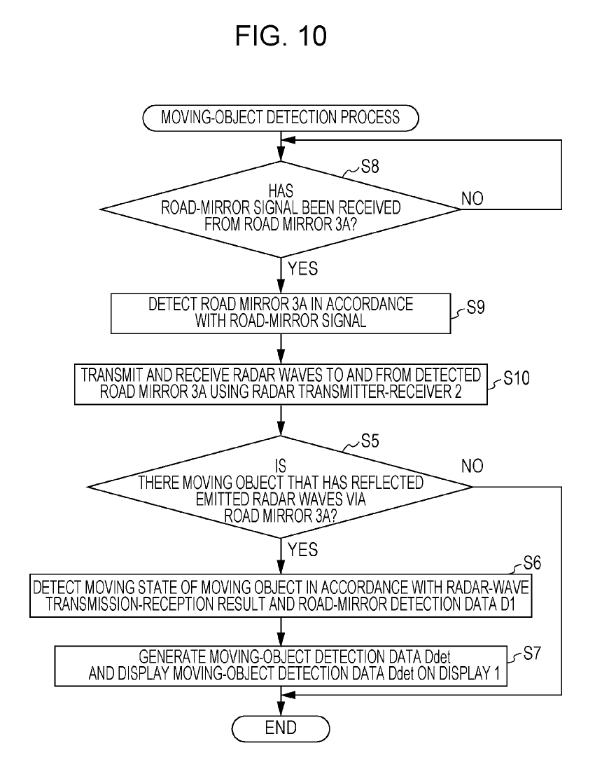

FIG. 10 is a flowchart illustrating a moving-object detection process performed by the object detection apparatus of FIG. 8. Compared with the moving-object detection process in FIG. 5, the controller 10 performs processing in steps S8 to S10 in the moving-object detection process in FIG. 10 instead of processing in steps S1 to S4. The other portions of the moving-object detection process in FIG. 10 are the same as those of the moving-object detection process in FIG. 5. The differences will be described in the following.

In FIG. 10, first, the controller 10 determines whether or not the road-mirror signal Smir has been received by the signal receiver 5 from the road mirror 3A (step S8). In the case where the road-mirror signal Smir has not been received by the signal receiver 5 (NO in step S8), the controller 10 repeatedly performs processing in step S8 at certain intervals. In contrast, in the case where the road-mirror signal Smir has been received by the signal receiver 5 (YES in step S8), the controller 10 detects the road mirror 3A in accordance with the road-mirror signal Smir (step S9). The road-mirror signal Smir transmitted from the road mirror 3A includes information indicating the location and the angle of the road mirror 3A, and the controller 10 acquires the information indicating the location and the angle of the road mirror 3A in step S9.

Next, the controller 10 transmits and receives radar waves to and from the detected road mirror 3A using the radar transmitter-receiver 2 (step S10). In step S10, the controller 10 transmits and receives radar waves using the radar transmitter-receiver 2 such that radar waves are emitted from the transmitting antenna 22 toward the road mirror 3A detected in step S9. In the following, the controller 10 performs processing in steps S5 to S7 as in those of the moving-object detection process in FIG. 5.

With the object detection apparatus configured as described above, the accuracy of detection of the location and the angle of the road mirror 3A may be improved by using the road-mirror signal Smir transmitted from the road mirror 3A.

In addition, the signal transmitter 33 includes a transmitter using specified low-power radio in the road mirror 3A according to the second embodiment. However, the transmitter is not limited to this type of transmitter. For example, the signal transmitter 33 may include an RFID-based IC tag or a transmitter based on wireless communication standards such as Wi-Fi or Bluetooth®.

In addition, the signal transmitter 33 is embedded inside the road mirror 3A in the road mirror 3A according to the second embodiment. However, the place where the signal transmitter 33 is provided is not limited to this in the present disclosure. For example, the signal transmitter 33 may be provided on the back side of the mirror 30 of the road mirror 3A.

### Third Embodiment

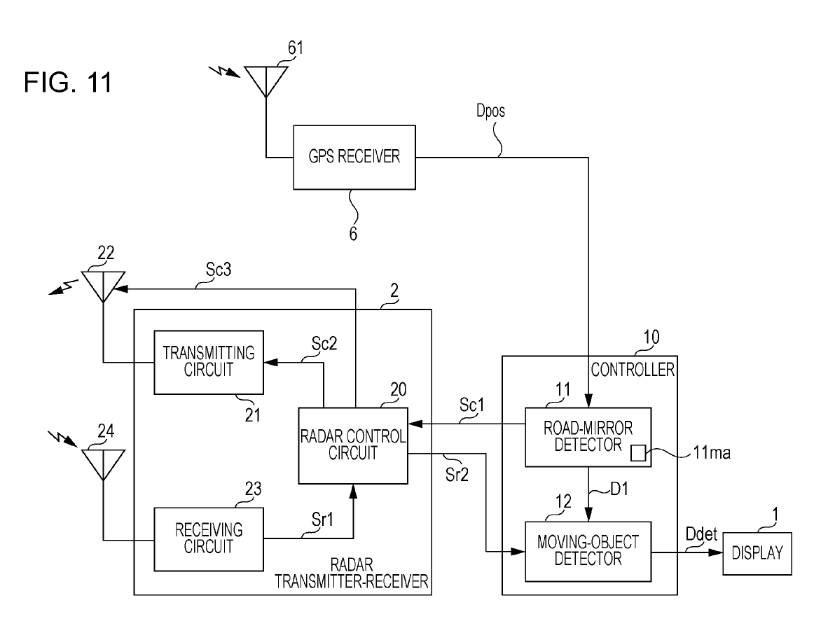

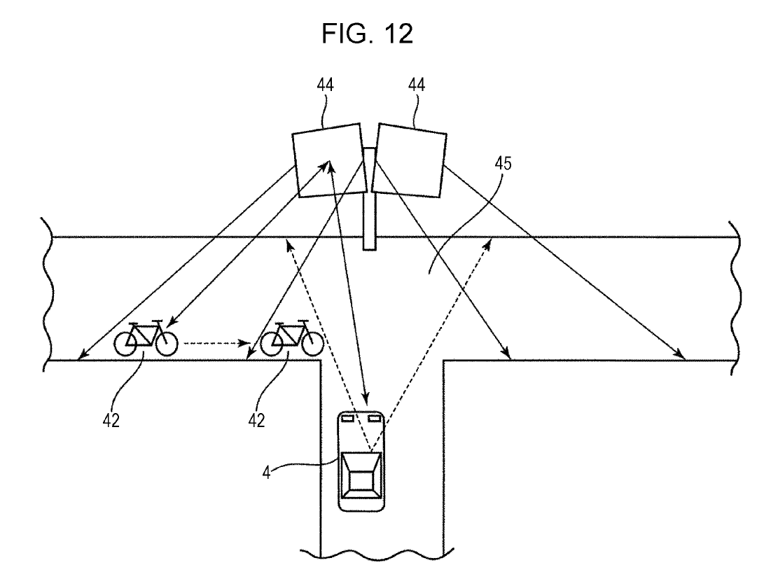

FIG. 11 is a block diagram illustrating the configuration of an object detection apparatus according to a third embodiment of the present disclosure. FIG. 12 is a perspective view illustrating the object detection apparatus of FIG. 11 and a pair of road mirrors 44. The object detection apparatus according to the second embodiment detects the road mirror 3A by receiving the road-mirror signal Smir using the signal receiver 5. The object detection apparatus according to the third embodiment detects road mirrors including conventional road mirrors, such as a single road mirror and a combination of a plurality of road mirrors. The pair of road mirrors 44 is an example of the conventional road mirrors. The object detection apparatus according to the third embodiment acquires map information regarding road mirrors including the conventional road mirrors and location information Dpos using a global positioning system (GPS), and detects the road mirrors.

Compared with the object detection apparatus according to the second embodiment, the object detection apparatus according to the third embodiment includes a GPS receiver 6 in FIG. 11 instead of the signal receiver 5. In addition, the object detection apparatus according to the third embodiment includes a memory 11ma. The other portions of the object detection apparatus according to the third embodiment are the same as those of the object detection apparatus according to the second embodiment. The differences will be described in the following.

In FIG. 11, the GPS receiver 6 includes a receiving antenna 61, receives GPS information from the receiving antenna 61, calculates the location information Dpos on the object detection apparatus in accordance with the GPS information, and outputs the location information Dpos to the controller 10. In the controller 10, the road-mirror detector 11 includes the memory 11ma. The memory 11ma stores map information including information on the locations and the angles of the road mirrors including the pair of road mirrors 44. The road-mirror detector 11 detects relative locations and angles of the road mirrors (e.g. the pair of road mirrors 44) and the automobile 4 in accordance with the map information and the location information Dpos.

In FIG. 12, the automobile 4 in which the object detection apparatus according to the present embodiment is mounted is about to enter a T-intersection 45 where the pair of road mirrors 44 are installed. The bicycle 42 is traveling at a location that is a blind spot of the automobile 4 at the T-intersection 45, and the bicycle 42 is not directly seen from the driver's seat of the automobile 4. The pair of road mirrors 44 are installed so as to reflect areas that are blind spots of the automobile 4 in both directions at the T-intersection 45. The object detection apparatus according to the present embodiment stores map information including the information on the locations and the angles of such road mirrors. The map information includes, for example, information on each of the angles of the road mirrors 44 facing the two directions as illustrated in FIG. 12.

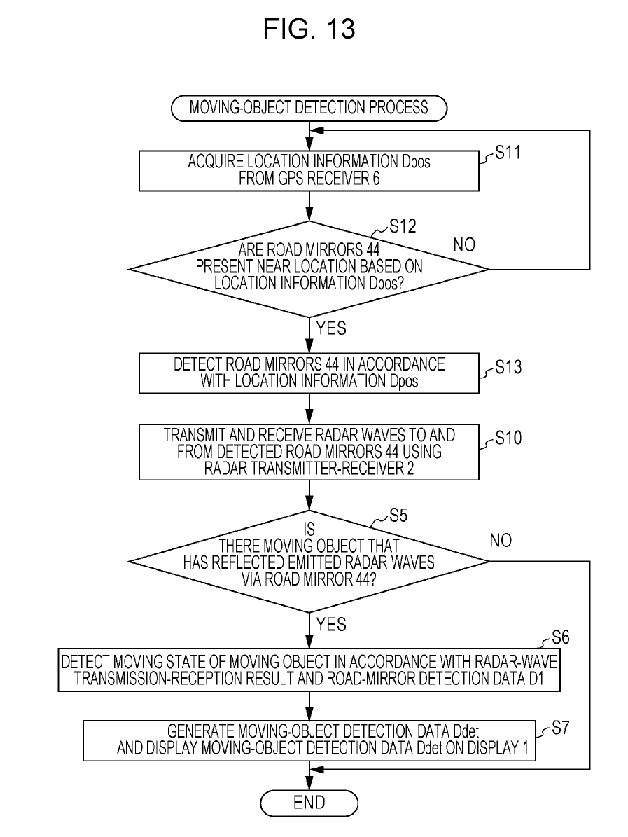

FIG. 13 is a flowchart illustrating a moving-object detection process performed by the object detection apparatus of FIG. 11. Compared with the moving-object detection process in FIG. 10, the controller 10 performs processing in 511 to S13 in the moving-object detection process in FIG. 13 instead of processing in steps S8 to S9. The other portions of the moving-object detection process in FIG. 13 are the same as those of the moving-object detection process in FIG. 10. The differences will be described in the following.

In FIG. 13, first, the controller 10 acquires the location information Dpos from the GPS receiver 6 (step S11). The controller 10 stores the acquired location information Dpos in the memory 11ma. Next, the controller 10 determines whether or not any of the road mirrors are present in the surroundings of the automobile 4 according to the map information stored in the memory 11ma (step S12). The determination process in step S12 is performed in accordance with whether or not, in information on road mirrors included in the map information, any of the road mirrors are present, which are road mirrors installed within a range of a certain distance, for example, 10 m ahead of the automobile 4 in accordance with the acquired location information Dpos. In the case where it is determined that no road mirrors are present in the surroundings of the automobile 4 according to the map information (NO in step S12), the controller 10 performs processing in step S11 again.

In contrast, in the case where it is determined that one or more of the road mirrors (e.g. the pair of road mirrors 44) are present in the surroundings of the automobile 4 according to the map information (YES in step S12), the controller 10 detects the one or more road mirrors (e.g. the pair of road mirrors 44) in step S13. The controller 10 detects the locations and the angles of the one or more road mirrors (e.g. the pair of road mirrors 44) in step S13 in accordance with the map information and the location information Dpos. In the following, the controller 10 performs processing in steps S10 and S5 to S7 as in those of the moving-object detection process in FIG. 10.

Since the object detection apparatus configured as described above detects the road mirrors using the location information Dpos and the map information, moving objects reflected in the road mirrors may be detected without installation of special equipment in the road mirrors.

In addition, in the object detection apparatus according to the third embodiment, the road-mirror detector 11 of the controller 10 detects the locations and the angles of the road mirrors including the conventional road mirrors in accordance with the location information Dpos acquired from the GPS receiver 6 and the map information stored in the memory 11ma. However, the information used for detection is not limited to the location information Dpos acquired from the GPS receiver 6 and the map information stored in the memory 11ma. For example, the road mirrors 3 and 3A according to the first and second embodiments may also be used together with the location information Dpos and the map information. As a result, the locations and the angles of road mirrors may be more accurately detected.

In addition, in the object detection apparatus according to the third embodiment, the road-mirror detector 11 stores the map information including information on the locations and the angles of the road mirrors in the memory 11ma; however, such map information does not have to be stored in the memory 11ma. For example, the object detection apparatus may include an interface circuit that establishes a connection to the Internet, and may acquire such map information from an external server via lines of the Internet.

### Fourth Embodiment

The object detection apparatus according to the second embodiment detects the road mirror 3A by receiving the road-mirror signal Smir using the signal receiver 5. An object detection apparatus according to a fourth embodiment detects road mirrors including the conventional road mirrors (e.g. the pair of road mirrors 44) in accordance with captured images of the road mirrors.

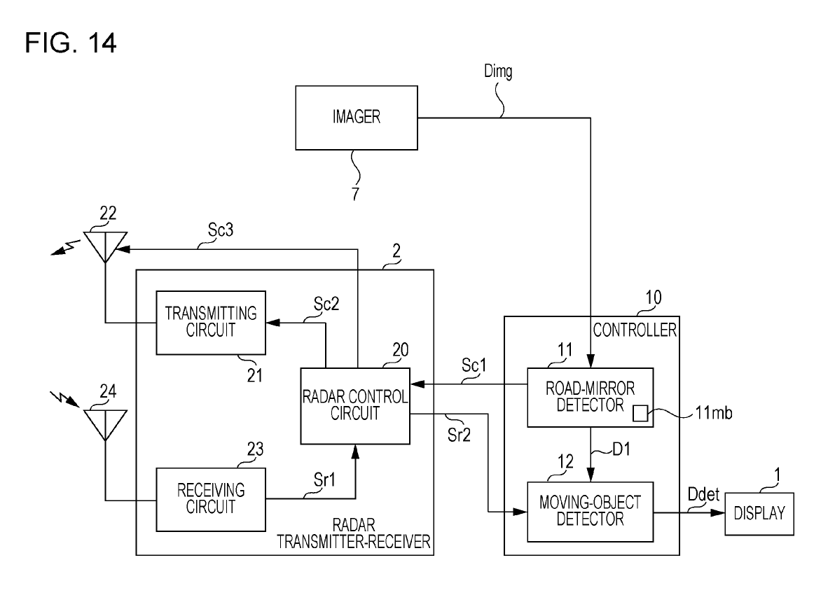

FIG. 14 is a block diagram illustrating the configuration of the object detection apparatus according to the fourth embodiment of the present disclosure. Compared with the object detection apparatus according to the second embodiment, the object detection apparatus according to the fourth embodiment includes an imager 7 instead of the signal receiver 5. In addition, the object detection apparatus of the fourth embodiment includes a memory 11mb. The other portions of the configuration of the object detection apparatus according to the fourth embodiment are the same as those of the configuration of the object detection apparatus according to the second embodiment. The differences will be described in the following.

In FIG. 14, the imager 7 includes, for example, a CCD camera, generates imaging data Dimg by performing an imaging operation, and outputs the imaging data Dimg to the controller 10. The imaging data Dimg is image data indicating an imaging result obtained by the imager 7. The imager 7 is attached to the automobile 4 such that an image of an area ahead of the automobile 4 in the direction in which the automobile 4 is traveling may be captured. In the controller 10, the road-mirror detector 11 includes the memory 11mb. The memory 11mb stores predetermined images of the road mirrors.

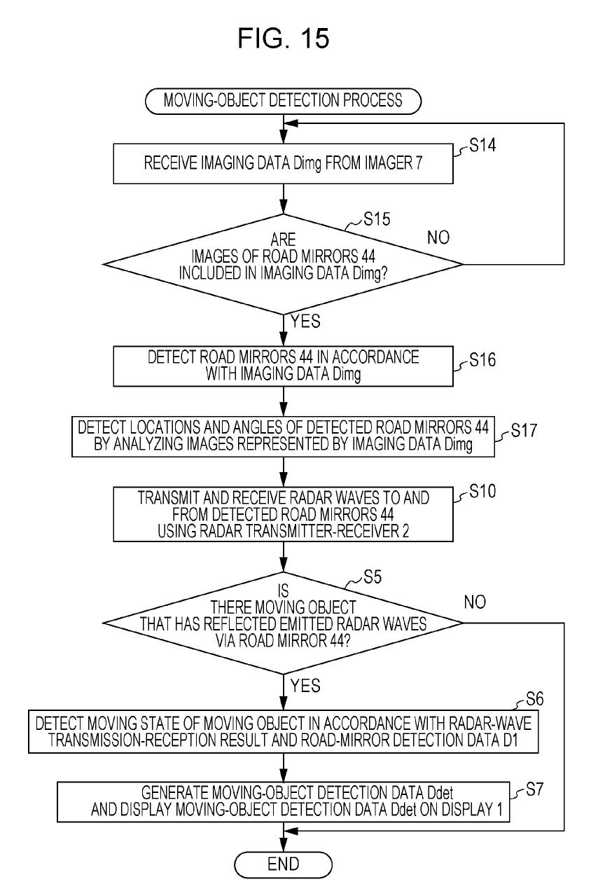

FIG. 15 is a flowchart illustrating a moving-object detection process performed by the object detection apparatus of FIG. 14. Compared with the moving-object detection process in FIG. 10, the controller 10 performs processing in steps S14 to S17 in the moving-object detection process in FIG. 15 instead of processing in steps S8 to S9. The other portions of the moving-object detection process in FIG. 15 are the same as those of the moving-object detection process in FIG. 10. The differences will be described in the following.

In FIG. 15, first, the controller 10 receives the imaging data Dimg from the imager 7 (step S14). Next, the controller 10 determines whether or not the received imaging data Dimg includes images of one or more road mirrors (e.g. the pair of road mirrors 44) (step S15). The controller 10 performs the determination process in step S15 by performing image analysis on the received imaging data Dimg. In the case where it is determined that the received imaging data Dimg does not include any images of the road mirrors (NO in step S15), the controller 10 performs processing in step S14 again.

In contrast, in the case where it is determined that the received imaging data Dimg includes images of one or more of the road mirrors (e.g. the pair of road mirrors 44) (YES in step S15), the controller 10 detects the one or more road mirrors (e.g. the road mirrors 44) (step S16). The controller 10 detects the locations and the angles of the detected one or more road mirrors (e.g. the pair of road mirrors 44) by comparing images represented by the imaging data Dimg on which image analysis has been performed with the predetermined road mirror images stored in the memory 11mb (step S17). In the following, the controller 10 performs processing in steps S10 and S5 to S7 as in those of the moving-object detection process in FIG. 10.

With the object detection apparatus configured as described above, since the road mirrors are detected by performing image analysis on images captured by the imager 7, the accuracy of detection of the locations and the angles of the road mirrors may be improved. In addition, moving objects reflected in the road mirrors may be detected with high accuracy without installation of special equipment in the road mirrors.

In addition, in the object detection apparatus according to the fourth embodiment, the controller 10 detects the road mirrors by performing image analysis on the imaging data Dimg. However, the way in which the road mirrors are detected is not limited to this. For example, the controller 10 may detect the road mirrors by combining captured images and information on a transmission-reception result of radar waves in accordance with the imaging data Dimg and the radar signal Sr2.

### Modification

In each of the object detection apparatuses according to the embodiments described above, the wireless-signal transmitter-receiver includes a millimeter-wave radar device. However, the wireless-signal transmitter-receiver is not limited to this. For example, the wireless-signal transmitter-receiver may include a radar device that emits radar waves having electromagnetic waves of frequency bands other than a millimeter-wave frequency band. In addition, the wireless-signal transmitter-receiver may include a laser radar device or an ultrasonic wave radar device.

In each of the object detection apparatuses according to the exemplary embodiments described above, the controller 10 detects a road mirror and also detects the angle of the road mirror; however, the way in which the angle of the road mirror is not limited to this. For example, after a road mirror is detected, the angle of the road mirror may be estimated in accordance with a positional relationship between the direction in which the automobile 4 is traveling and a road.

In each of the object detection apparatuses according to the exemplary embodiments described above, the controller 10 detects the direction of travel of a moving object in accordance with the calculated location of the moving object with respect to a road mirror and the detected relative speed V; however, the way in which the direction of travel of the moving object is detected is not limited to this. For example, the controller 10 may detect whether the direction of travel of the moving object is the direction in which the moving object is approaching the object detection apparatus or the direction in which the moving object is moving away from the object detection apparatus by determining whether the difference in frequency between a radar wave and a reflected wave received from the moving object via the road mirror is plus or minus.

### Summary of Embodiments

An object detection apparatus according to a first aspect of the present disclosure includes: wireless-signal transmitting-receiving circuitry that transmits a wireless signal to a road mirror among one or more road mirrors provided at predetermined locations and receives a reflected-wave signal reflected by the road mirror, and
control circuitry that detects the road mirror among the one or more road mirrors, and detects the presence of a moving object in accordance with
   (A) the transmitted wireless signal, and
   (B) the reflected-wave signal, which includes a signal received by the wireless-signal transmitting-receiving circuitry when at least part of the transmitted wireless signal is reflected by the road mirror and then reaches the moving object and is reflected by the moving object and then reaches the road mirror and reflected by the road mirror and then reaches the object detection apparatus.

According to the object detection apparatus according to the first aspect of the present disclosure, compared with the related art, a moving object reflected in a road mirror may be detected with high accuracy.

An object detection apparatus according to a second aspect of the present disclosure is the object detection apparatus according to the first aspect of the present disclosure, in which
when the control circuitry detects the presence of the moving object, the control circuitry calculates, in accordance with the transmitted wireless signal and the reflected-wave signal, at least one selected from the group consisting of a relative location of the moving object, a relative moving speed of the moving object, and a relative direction of travel of the moving object with respect to the object detection apparatus.

According to the object detection apparatus according to the second aspect of the present disclosure, the location, the moving speed, the direction of travel and the like of the moving object may be detected with high accuracy by calculating at least one selected from the group consisting of a location, the moving speed, and the direction of travel of the moving object the presence of which has been detected in accordance with the transmitted wireless signal and the reflected-wave signal.

An object detection apparatus according to a third aspect of the present disclosure is the object detection apparatus according to the first or second aspect of the present disclosure, in which
the control circuitry includes a memory that stores one or more reflection patterns indicating intensity distributions of reflected-wave signals reflected by the one or more road mirrors, and
the control circuitry detects the road mirror among the one or more road mirrors by determining whether or not the reflected-wave signal received by the wireless-signal transmitting-receiving circuitry has one of the stored reflection patterns.

According to the object detection apparatus according to the third aspect of the present disclosure, the presence of the road mirror may be detected with high accuracy by determining whether or not the reflected-wave signal received by the wireless-signal transmitting-receiving circuitry has a stored reflection pattern.

An object detection apparatus according to a fourth aspect of the present disclosure is the object detection apparatus according to the first or second aspect of the present disclosure, in which
the one or more mirrors transmit predetermined road-mirror signals, and
the control circuitry receives one of the road-mirror signals transmitted from the road mirror among the one or more road mirrors, and detects the road mirror among the one or more road mirrors in accordance with the received road-mirror signal.

According to the object detection apparatus according to the fourth aspect of the present disclosure, the location and the angle of the road mirror may be detected with high accuracy by using the road-mirror signal transmitted from the road mirror.

An object detection apparatus according to a fifth aspect of the present disclosure is the object detection apparatus according to the first or second aspect of the present disclosure and further includes information acquisition circuitry that acquires map information including information on the one or more road mirrors, wherein
the control circuitry detects, in accordance with the map information acquired from the information acquisition circuitry, the road mirror among the one or more road mirrors.

According to the object detection apparatus according to the fifth aspect of the present disclosure, since the detection is performed in accordance with the map information acquired from the information acquisition circuitry, a moving object reflected in the road mirror may be detected without installation of special equipment in the road mirror.

An object detection apparatus according to a sixth aspect of the present disclosure is the object detection apparatus according to the first or second aspect of the present disclosure and further includes an imaging device that captures one or more images, wherein
the control circuitry detects the road mirror among the road mirrors by analyzing the one or more images captured by the imaging device.

According to the object detection apparatus according to the sixth aspect of the present disclosure, since the road mirror is detected by performing image analysis on the images captured by the imaging device, the accuracy of detection of the location and the angle of the road mirror may be improved. In addition, a moving object reflected in the road mirror may be detected with high accuracy without installation of special equipment in the road mirror.

A road mirror according to a seventh aspect of the present disclosure is the road mirror detected by the object detection apparatus according to the third aspect of the present disclosure, and includes one or more reflectors that reflect the wireless signal supplied from the wireless-signal transmitting-receiving circuitry so as to form the reflection pattern.

According to the road mirror according to the seventh aspect of the present disclosure, compared with the related art, a moving object reflected in the road mirror may be detected with high accuracy by the object detection apparatus.

A road mirror according to an eighth aspect of the present disclosure is the road mirror detected by the object detection apparatus according to the fourth aspect of the present disclosure, and includes signal transmitting circuitry that transmits the road-mirror signal.

According to the road mirror according to the eighth aspect of the present disclosure, the presence of the road mirror may be detected with high accuracy by the object detection apparatus using the road-mirror signal transmitted from the road mirror.

What is claimed is:

1. An object detection apparatus comprising:
wireless-signal transmitting-receiving circuitry that transmits a wireless signal to a road mirror among one or more road mirrors provided at predetermined locations and receives a reflected-wave signal reflected by the road mirror, and
control circuitry that detects the road mirror among the one or more road mirrors, and detects the presence of a moving object in accordance with
(A) the transmitted wireless signal, and
(B) the reflected-wave signal, which includes a signal received by the wireless-signal transmitting-receiving circuitry when at least part of the transmitted wireless signal is reflected by the road mirror and then reaches the moving object and is reflected by the moving object and then reaches the road mirror and reflected by the road mirror and then reaches the object detection apparatus.

2. The object detection apparatus according to claim 1, wherein when the control circuitry detects the presence of the moving object, the control circuitry calculates, in accordance with the transmitted wireless signal and the reflected-wave signal, at least one selected from the group consisting of a relative location of the moving object, a relative moving speed of the moving object, and a relative direction of travel of the moving object with respect to the object detection apparatus.

3. The object detection apparatus according to claim 1, wherein
the control circuitry includes a memory that stores one or more reflection patterns indicating intensity distributions of reflected-wave signals reflected by the one or more road mirrors, and
the control circuitry detects the road mirror among the one or more road mirrors by determining whether or not the reflected-wave signal received by the wireless-signal transmitting-receiving circuitry has one of the stored reflection patterns.

4. The object detection apparatus according to claim 1, wherein
the one or more mirrors transmit predetermined road-mirror signals, and
the control circuitry receives one of the road-mirror signals transmitted from the road mirror among the one or more road mirrors, and detects the road mirror among the one or more road mirrors in accordance with the received road-mirror signal.

5. The object detection apparatus according to claim 1, further comprising information acquisition circuitry that acquires map information including information on the one or more road mirrors, wherein
the control circuitry detects, in accordance with the map information acquired from the information acquisition circuitry, the road mirror among the one or more road mirrors.

6. The object detection apparatus according to claim 1, further comprising an imaging device that captures one or more images, wherein
the control circuitry detects the road mirror among one or more the road mirrors by analyzing the one or more images captured by the imaging device.

7. A road mirror that is detected by an object detection apparatus,
the object detection apparatus comprising:
wireless-signal transmitting-receiving circuitry that transmits a wireless signal to the road mirror and receives a reflected-wave signal reflected by the road mirror, and
control circuitry including a memory that stores a plurality of reflection patterns including a reflection pattern indicating an intensity distribution of the reflected-wave signal reflected by the road mirror,
the control circuitry detecting the road mirror by determining whether or not the reflected-wave signal received by the wireless-signal transmitting-receiving circuitry has the reflection pattern among the plurality of reflection patterns,
the control circuitry detecting the presence of a moving object in accordance with (A) the transmitted wireless signal, and (B) the reflected-wave signal, which includes a signal received by the wireless-signal transmitting-receiving circuitry when at least part of the transmitted wireless signal is reflected by the road mirror and then reaches the moving object and is reflected by the moving object and then reaches the road mirror and reflected by the road mirror and then reaches the object detection apparatus, wherein
the road mirror comprises one or more reflectors that reflect the wireless signal supplied from the wireless-signal transmitting-receiving circuitry so as to form the reflection pattern.

8. A road mirror that is detected by an object detection apparatus, the road mirror comprising signal transmitting circuitry that transmits a road-mirror signal,
the object detection apparatus comprising:
wireless-signal transmitting-receiving circuitry that transmits a wireless signal to the road mirror and receives a reflected-wave signal reflected by the road mirror, and
control circuitry that receives the road-mirror signal transmitted from the road mirror, and detects the road mirror in accordance with the received road-mirror signal, and detects the presence of a moving object in accordance with
(A) the transmitted wireless signal, and
(B) the reflected-wave signal, which includes a signal received by the wireless-signal transmitting-receiving circuitry when at least part of the transmitted wireless signal is reflected by the road mirror and then reaches the moving object and is reflected by the moving object and then reaches the road mirror and reflected by the road mirror and then reaches the object detection apparatus.
